(19) United States
(12) Patent Application Publication
(10) Pub. No.: US 2026/0272159 A1
(43) Pub. Date: Sep. 17, 2026

(54) MODULAR ILLUMINATED SHELF ASSEMBLY

(71) Applicant: DIAM UK LTD, Leicestershire (GB)

(72) Inventors: Eamonn Kerr, Leicestershire (GB); Louise Natasha Scott, Leicestershire (GB)

(73) Assignee: DIAM UK LTD, Leicestershire (GB)

(21) Appl. No.: 19/560,967

(22) Filed: Mar. 9, 2026

Related U.S. Application Data
(60) Provisional application No. 63/768,265, filed on Mar. 7, 2025.

(51) Int. Cl. A47B 47/00; F21V 23/00; F21V 23/06; F21V 33/00; F21Y 115/10

(52) U.S. Cl. CPC A47B 47/0091; F21V 23/001; F21V 23/06; F21V 33/006; A47B 2220/0069; A47B 2220/0075; F21Y 2115/10

(57) ABSTRACT

A modular shelving assembly comprises a carrier configured to be mounted to a support wall and a shelf configured to attach to the carrier to form a hinge that allows the shelf to be opened or folded up against the carrier. The hinge is configured to lock the shelf in place when it is open and also when it is close. The carrier and the shelf can each be integrally molded as a single plastic component. An integrated lighting system can be attached to the shelf. Electrical couplers attached to the shelf and the lighting system allow adjacent shelves to be easily electrically connected wherein a power supply connected to one shelf provides power to all of the shelves.

### CROSS REFERENCE TO RELATED APPLICATION

This application claims priority under 35 U.S.C. § 119 to U.S. Provisional Patent Application No. 63/768,265, filed on Mar. 7, 2025, the disclosure of which is incorporated by reference herein in its entirety.

### TECHNICAL FIELD

The present invention is related to modular shelving assemblies for displaying goods.

### BACKGROUND

Modular shelving systems are frequently used at point of sale location to display goods to customers. The modular nature allows the shelves to be positioned at desired locations on a support wall. Often a shelving system will need to have display shelf area on which goods are placed and a back wall for decorative purposes and to hide the mounting hardware. One solution provides the back wall and the shelf as separate components that can be mounted to the support wall. To avoid having to mount both the shelf and back wall separately, a combined shelf system can include both. These can be connected with hinge so the shelf can be folded, such as for transportation.

A hinged shelving system of this type can require numerous components, complicating assembly and increasing weight. There is a need for an improved hinged modular shelving system that can be made economically with reduced weight and materials relative to conventional systems.

Display systems also often include lights to illuminate goods on the shelves. These lights are often mounted under the shelf so that lights on one shelf will light up goods on the shelf immediately below it. To power the lights, these doing assembly of the system at the store location will need to connect the lights to a power source. It would be a further advantage to provide such an improved modular shelving system with integrated lighting on each shelf and where the lighting on each shelf can be easily connected to a power source when the shelving system is assembled.

### BRIEF DESCRIPTION OF THE FIGURES

Further features and advantages of the invention, as well as structure and operation of various implementations of the invention, are disclosed in detail below with references to the accompanying drawings in which:

FIG. 1.1 shows a shelf assembly in an open position;

FIG. 1.2 shows the shelf assembly in a closed position;

FIGS. 1.3-1.5 are top, bottom, and side views of the open shelf assembly 100 of FIG. 1.1;

FIG. 1.6 is a side view of the carrier portion of the shelf assembly;

FIG. 1.7 is a side view of the shelf portion of the shelf assembly;

FIG. 2.1 shows a plurality of shelf assemblies mounted to a support wall;

FIGS. 2.2 and 2.3 are detail views of the electronic connections between the shelf assemblies;

FIG. 2.4 shows the underside of an open shelf assembly;

FIG. 2.5 shows exemplary electrical connectors that can be used in the shelf assembly;

FIG. 3 details an embodiment of a wire routing configuration on the underside of a shelf;

FIGS. 4.1-4.3 show the hinged shelf relative to the carrier in an open, closed, and intermediate position;

FIGS. 5.1 – 5.6 are detailed views of elements of the hinge assembly; and

FIGS. 6.1-6.6 are figures detailing the interaction of elements of the hinge assembly when the shelf is opened and closed.

### DETAILED DESCRIPTION

A modular shelf assembly as disclosed herein comprises a carrier and a shelf that is mounted to carrier on a hinge assembly. The shelf can be folded up to a closed position relative to the carrier for easy shipping and storage and can be opened up for use. The carrier and shelf can be molded as separate integral components that include the components for hinge assembly. The hinge assembly is configured so that the two components can be easily joined together, such as during manufacturing, and includes features that will lock the carrier and shelf in a closed position for shipment and manipulation during installation, and an open position in use.

The carrier has a rear bracket that allows the carrier to be mounted to a support wall, where the bracket can be configured as need to engage the support wall at issue. Each shelf has a downward facing lighting assembly, such as one or more LED strip lights, integrated therein and an electrical connector system that allows power to be connected from one shelf to an adjacent shelf during assembly. Once so connected, all the shelves can be powered by connecting one shelf to a power supply.

Advantageously, the new shelving assembly can be used to provide illumination to display items without having to integrate lighting into the product trays. The structure is eco-designed to be light weight, reduce material usage, and to minimize packaging.

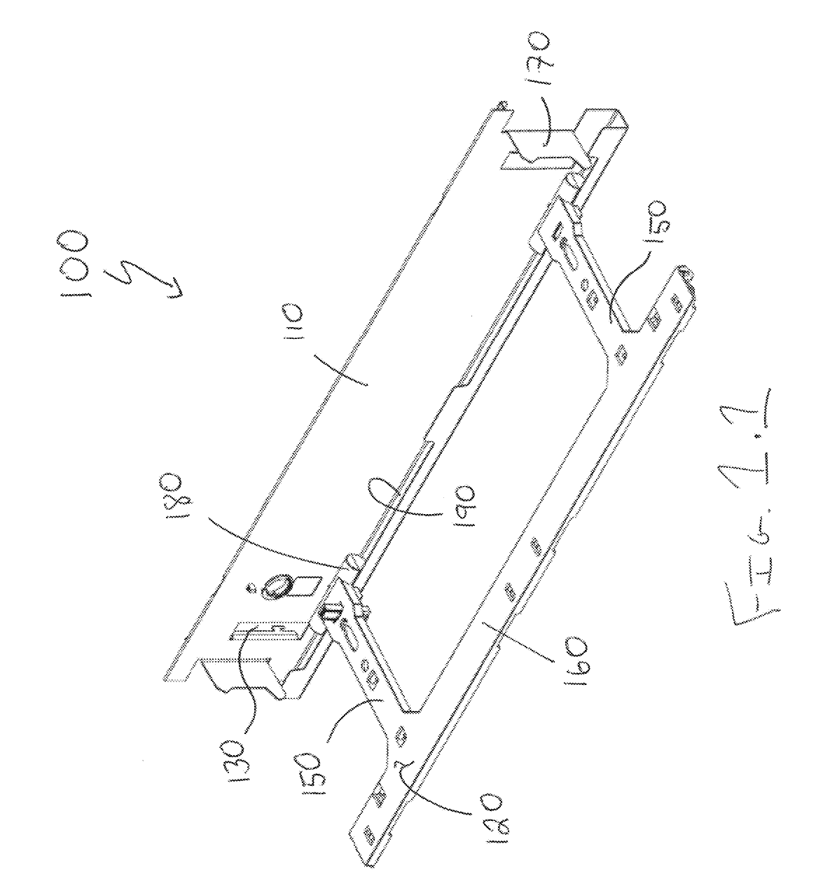

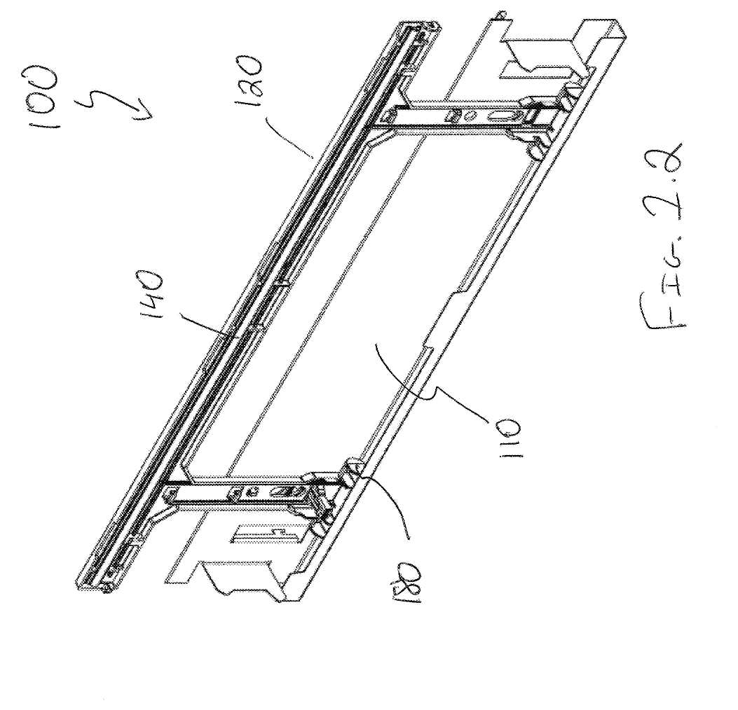

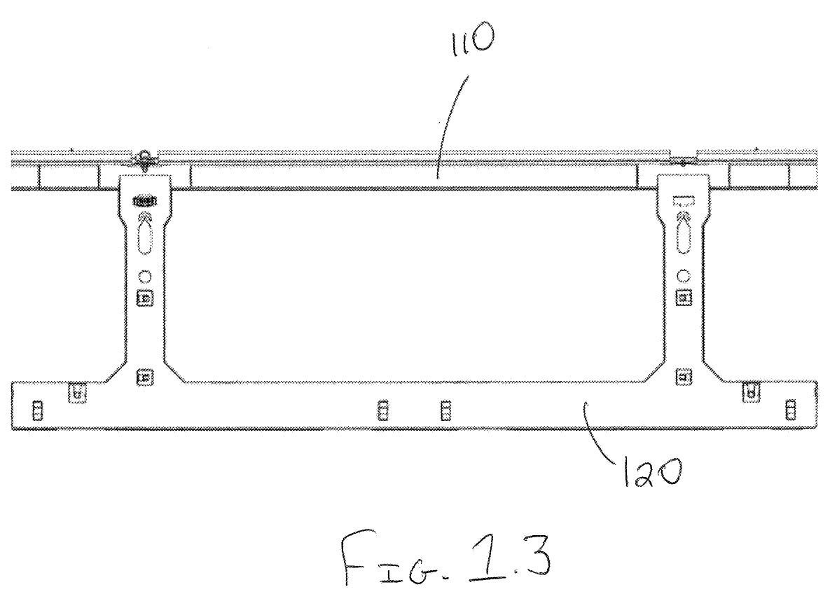

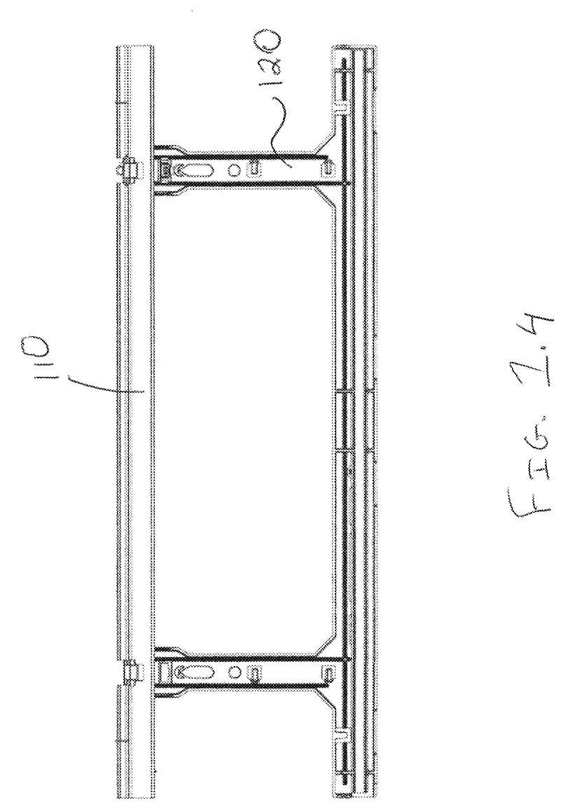

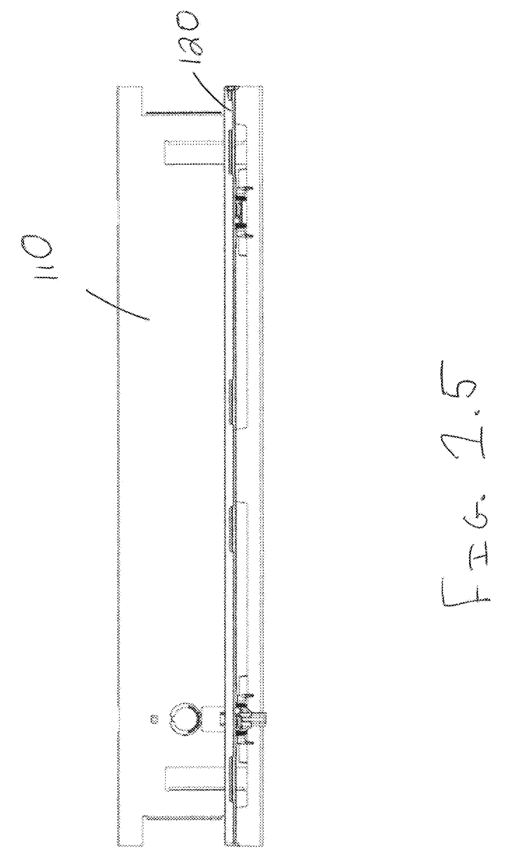

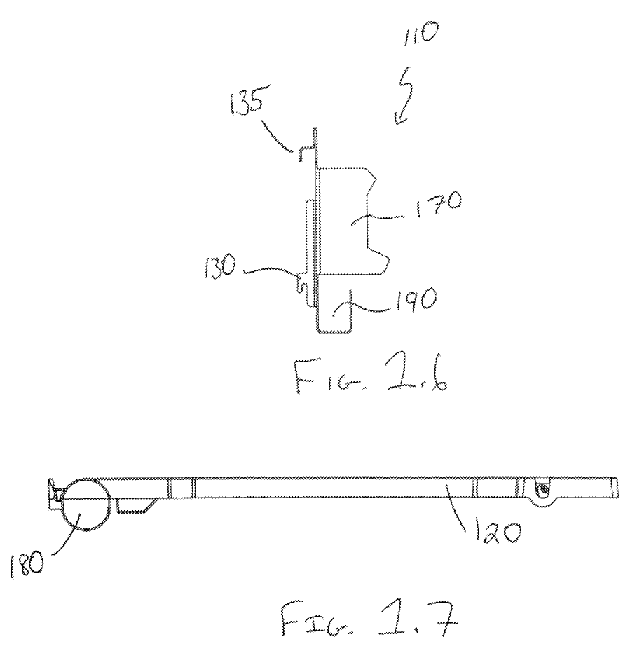

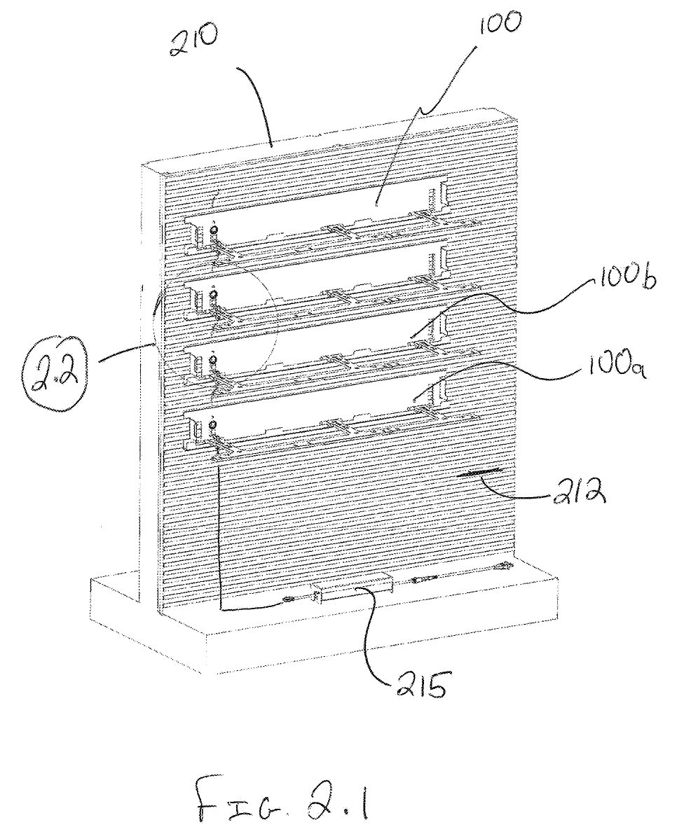

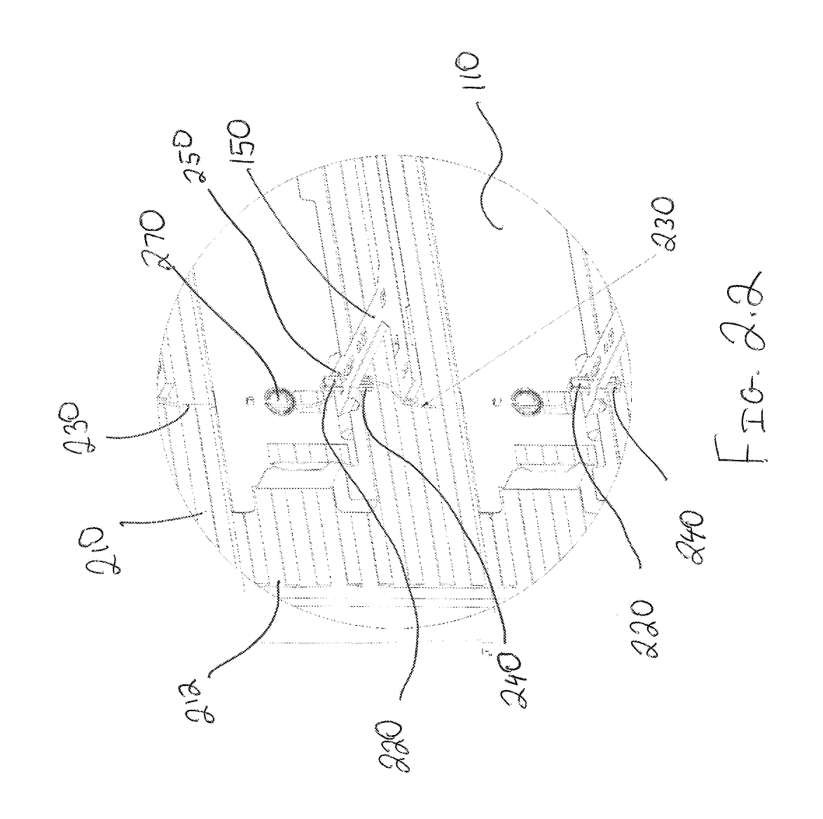

FIGS. 1.1 – 1.7 show multiple views of such an improved modular shelf assembly 100. Shelf assembly 100 comprises a carrier 110 and shelf 120 hingedly mounted to the carrier 110. A plurality of shelf assemblies can be mounted to a support wall as discussed further below and as shown, for example, in FIG. 2.1. The shelf 120 can be folded up to a closed position relative to the carrier 110 for easy shipping and storage and can be opened up for use. FIG. 1.1 shows shelf assembly 100 in an open position. FIG. 1.2 shows shelf assembly 100 in a closed position. FIG. 1.3 is a top view of the open shelf assembly 100 of FIG. 1.1. FIG. 1.4 is a bottom view of the open shelf assembly 100 of FIG. 1.1. FIG. 1.5 is a front view of the open shelf assembly 100 of FIG. 1.1. FIG. 1.6 is a side view of the carrier 110 without the shelf 120 removed for clarity. FIG. 1.7 is a side view of the shelf 120 without the carrier 110.

The carrier 110 can be mounted to the support wall using a plurality of rear brackets of that are configured to engage mounting areas on the support wall. The brackets can be configured as appropriate to engage the support wall at issue. In the illustrated embodiment, pairs of upper and lower brackets 130, 135 are used to engage slots in the support wall.

Shelf 120 has one or more support arms 150 that are hingedly coupled to the carrier 110 by means of a hinge assembly comprising a cylindrical barrel 180 at the back end of the support arm 150 that fits within a channel 190 in the carrier 110. A forward cross bar 160 is connected to the support arms. A lighting assembly 140, such as a light strip can be mounted on the underside of the cross bar 160.

The carriers 110 can have one or more forward extending flanges 170 on which additional components can be mounted, such as a decorative back to obscure the support wall and the carrier 110, and/or shelving sides side walls (not shown). In one embodiment, the shelf 120 does not need to be load bearing. Instead a separate display shelf (not shown) can be mounted above shelf 120. For example, a display shelf can be mounted to carrier 110, such as by mounting to the flanges 170, and positioned so that it is above shelf 120, possibly with a small gap between the display shelf and shelf 120. Alternatively, cross-bar 160 and support arms 150 can be configured to be sufficiently strong to directly support a display shelf or other display items.

In an embodiment, the carrier 110 and shelf 120 are each integrally molded as a single plastic component. Other fabrication techniques can be used, such as forming one or both components out of punched metal. In the illustrated embodiment, two support arms 150 are shown. More than two support arms 150 can be used as well, such as for longer shelves and/or to increase the load capacity of the shelf assembly 100. Likewise, a shelf 120 could have only a single arm, such as a centrally mounted arm 150. In the illustrated embodiment, the support arms 150 are elongated front to back. The length and width of the arms can be varied as appropriate for the specific shelving application.

FIG. 2.1 shows a plurality of shelf assemblies 100 mounted to slots 212 on a support wall 210. FIGS. 2.2 and 2.3 are detail views of the electronic connections between the shelf assemblies 100. FIG. 2.4 shows the underside of an open shelf assembly 100.

Referring to FIGS. 2.1-2.4, multiple shelf assemblies 100 can be mounted to the support wall 210. A first shelf assembly, such as a bottom shelf assembly 100a, can be connected to a power supply 215. The remaining shelf assemblies can be electrically connected to adjacent shelf assemblies. For example, shelf assembly 100b electrically connects to shelf assembly 100a. The electrical connection to a given shelf assembly comprises a first type electrical connector to receive power (e.g., male or female) and a second type electrical connector that can mate to the first connector type (e.g., female or male). The power fed to a given shelf assembly 100 can be used to drive the lighting assembly 140 on the underside of the shelf 120 of that assembly 100. The lighting assemblies 140 can be configured so that each provides illumination for the shelf 120 of the shelf assembly 100 below.

In the embodiments shown in the figures, electrical connections between shelf assemblies 100 are made using first and second connectors 220, 240 which engage each other. At least one of the connectors 220, 240 can also be mechanically connected to the shelf assembly 100. For example, a first connector 220 is vertically mounted through an aperture 250 in one of the support arms 150 of a shelf 120, such as the leftmost or rightmost support arm, and is positioned adjacent to the hinge assembly. Advantageously, a vertical mounting of the upper connector 220, such as through aperture 250, can simplify assembly by allowing the connector 220 to easily snap onto the aperture 250 passing through the support arm 150. In this arrangement, the connector itself carries the circuitry through the shelf 120. While the connector 220 is shown as being vertically mounted to shelf, other configurations are also possible. For example, a connector could be mounted sideways on the top or underside of the shelf 120.

The mating portion of the connector 220 is accessible from the bottom of the shelf. (See FIG. 2.4). Extending from the first connector 220 is an elongated wire spur 230 terminating with a second connector 240. The second connector 240 at the end of the spur 230 from a lower shelf can be connected to the first connector 220 of a shelf above it. The wire spur can be passed through an opening in the carrier 110 of a shelf assembly, such as a grommet 270, so at least part of the wire spur can be positioned between the carrier 110 and the support wall 210. The arrangement could also be reversed with the wire spur 230 extending from the connector 240 connector and terminating with another connector 220.

As shown in FIGS. 21 and 2.2, a power supply 215 can be connected to one of the shelf assemblies 100, such as the lowermost one 100a. Upper shelves can be connected sequentially to the one below so that power is provided to each shelf. The shelf assemblies can be universally configured so any power cable connecting to the bottom shelf to start the chain uses the same connector used to connect one shelf assembly to another shelf assembly. In the illustrated embodiment,

A power feed 260 extending from a connector, such as connector 220, is used to provide power to the lighting assembly 140 on a given shelf assembly 100. It can also be used to power other components on the shelf assembly 100. Other types of wired connections can also be made through the connectors 220, 240. For example, in addition to providing power, connectors 220, 240 can be used to carry data or control signals between shelf assemblies 100. Connections to these signals on each shelf assembly can be provided and used, for example, to controllably vary a lighting display or to drive additional elements, such as digital signage (not shown) that could be connected to a shelf 120. For example, the LED lighting bar may allow selection of different colors, or the shelving unit can be provided with an “attract mode” lighting pattern that can draw the attention of a consumer.

FIG. 2.5 shows an exemplary connector assembly that can be used in system 100 where only basic power connection is required. In this embodiment, connector 220 is female and has snap arms 270 configured so that the connector 220 can be press fit into place within the aperture 250. Connector 240 is male and is mounted to the end of the wire spur 230. Wires 260 extending from connector 220 provide power to the lighting assembly 140. The specific type and configuration of the connectors 220, 240 are dependent on the manner in which they are connected to the shelving assembly 100 and on the type and number of electrical connections that are desired. Suitable connectors will be known to those or ordinary skill in the art.

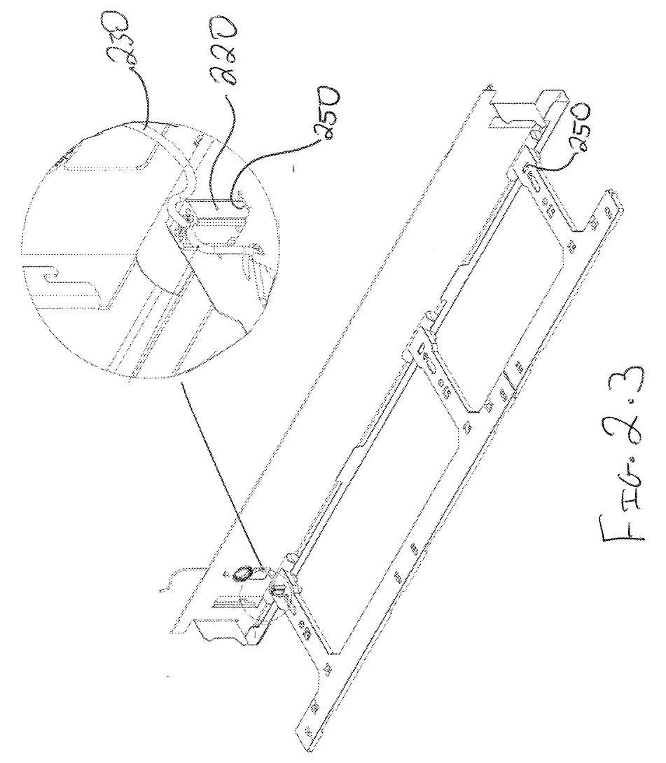

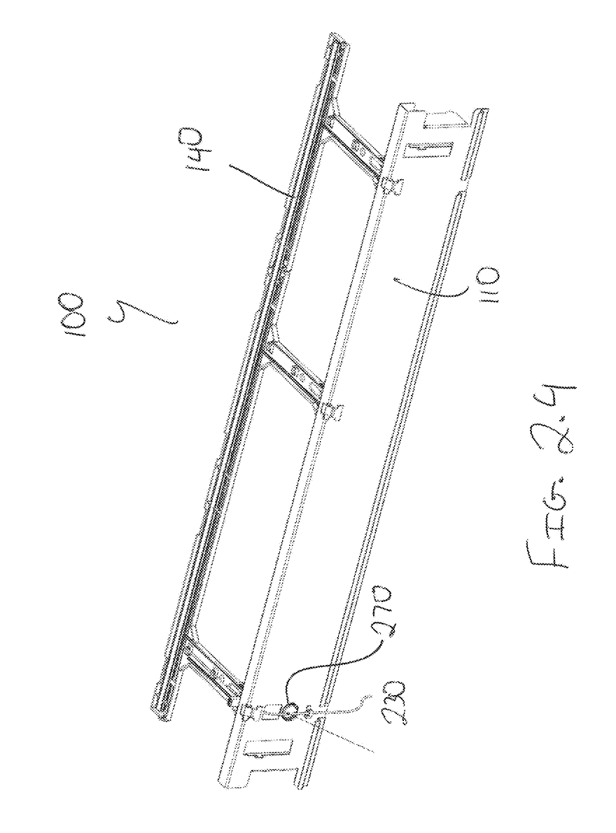

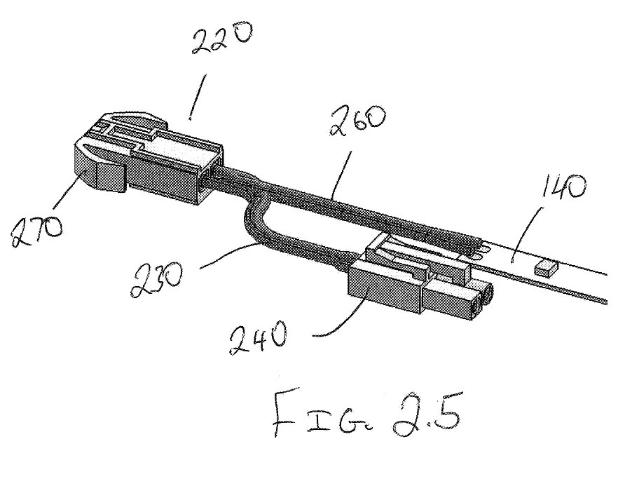

FIG. 3 details an embodiment of a wire routing configuration on the underside of a shelf 120. A cable 310 extends from the 220 connector along channel 315 the underside of a support arm 150 connects to the lighting assembly 140, which can be an LED strip light clipped or otherwise attached to the bottom of the cross bar 160. A plurality of clips 320 can be used to hold the cable 310 in place.

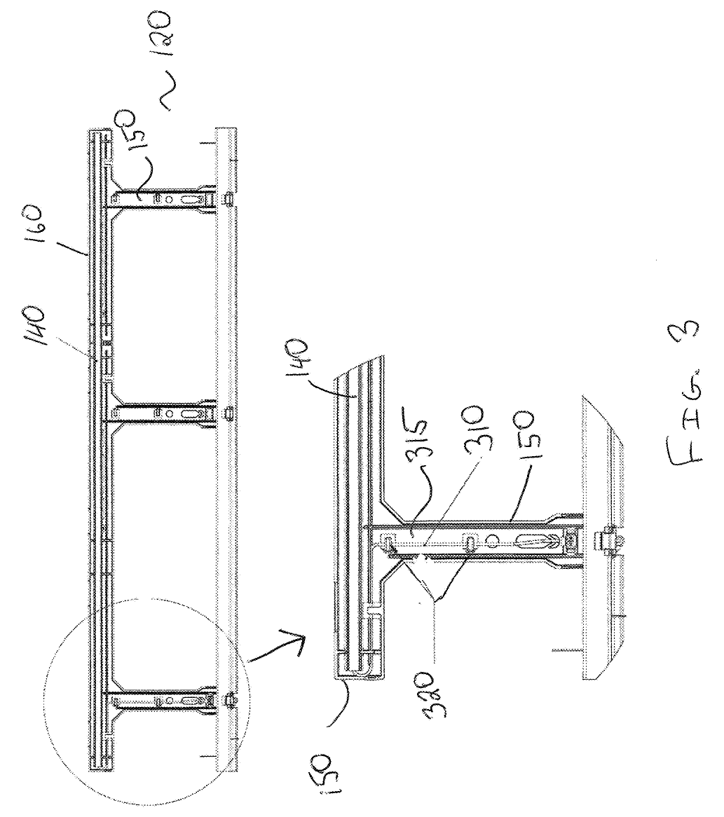

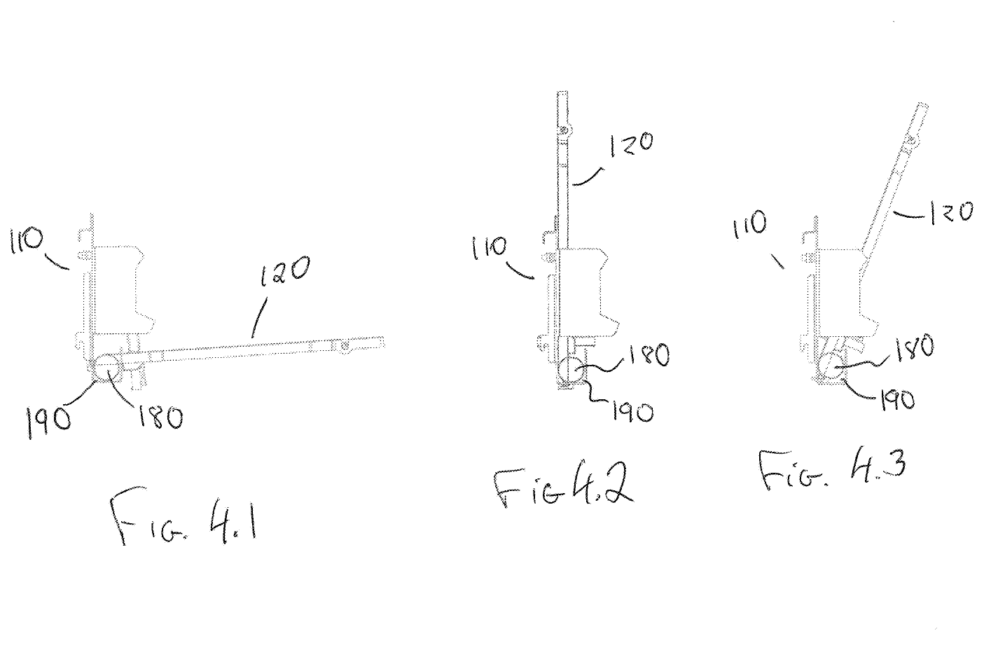

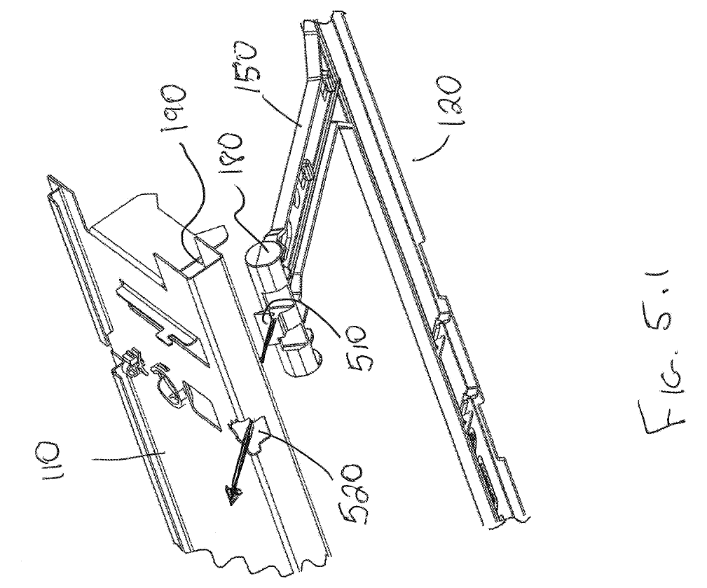

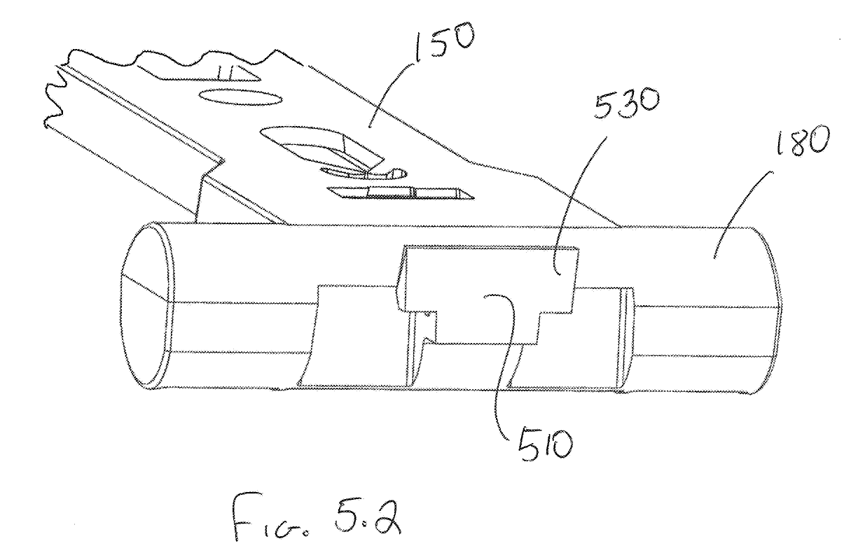

FIGS. 4.1-4.3 show various positions of the shelf 120 relative to the carrier 110 that are provided by the hinge assembly. FIG. 4.1 shows the mounted shelf 120 in the open position relative to the carrier 110. FIG. 4.2 shows the shelf 120 in the closed position relative to the carrier 110. FIG. 4.3 shows an intermediate angled position of the shelf 120 relative to carrier where the shelf 120 and carrier 110 can be coupled to or separated from each other. The shelf and carrier 110 can be coupled to each other prior to shipment to point of sale location for installation on a support wall.

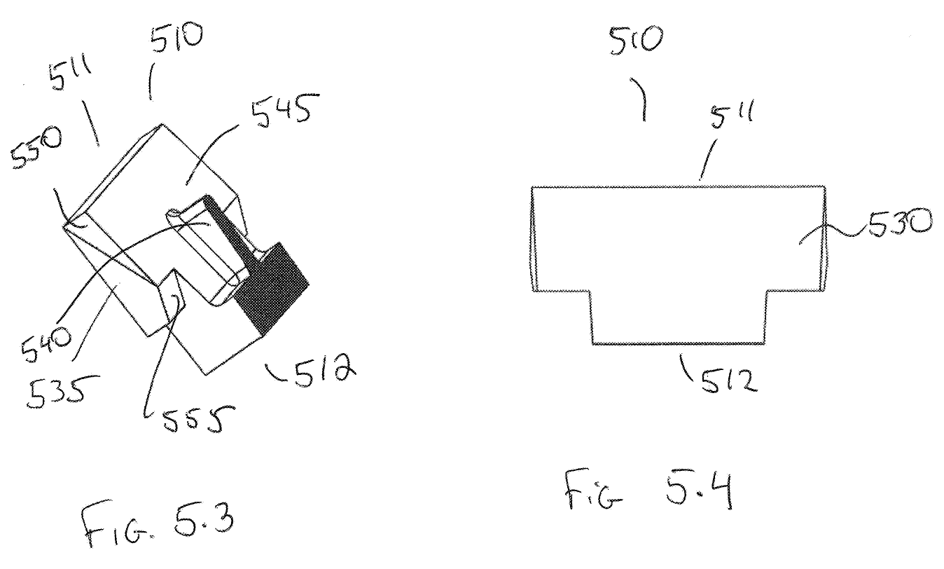

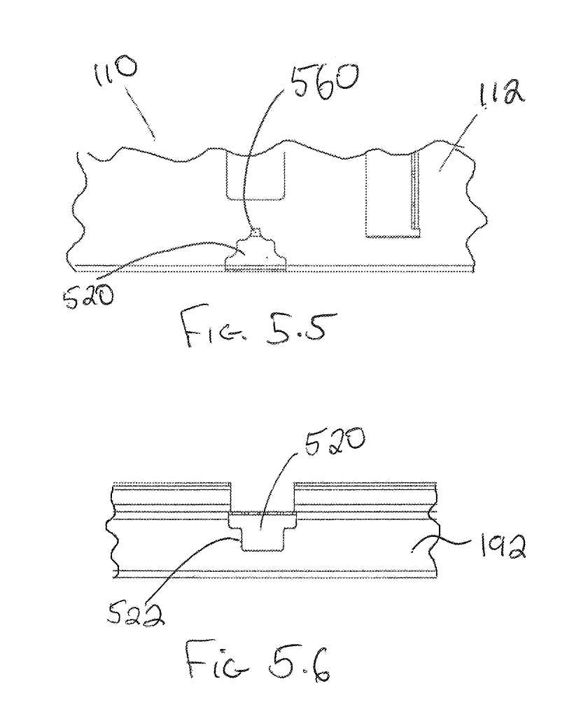

FIGS. 5.1 – 5.5 illustrate the configuration of the hinge assembly. FIG. 5.1 shows an exploded bottom perspective view of a portion of the carrier 110 and shelf 120. Barrel 180 is mounted to the end of the support arm 150. A paddle 510 extends backwards from the barrel 180. FIG. 5.2 shows a detailed rear view of a barrel portion 180 of a shelf support arm 150 and paddle 510. FIG. 5.3 shows a perspective view of the paddle 510 with the barrel 180 and other shelf portions hidden. Paddle 510 has a top 511 and bottom 512. A pair of opposing arms 530 extending out to the sides and a locking rib 540 extending outwards from inner face 545. A top portion 550 of the arms can be beveled towards the face 545 to give the top edge of the paddle 510 a wedge shape to assist in fitting the paddle 510 through the aperture 520 when the shelf 110 is installed. A bottom part of the face 545 can be beveled to form a cam surface 555 which will engage the bottom of the channel 192 when the shelf is closed as described further below.

FIG. 5.5 shows a rear view of a portion of carrier 110 detailing aperture 520 on the back wall of the 112 of the carrier 110. Aperture 520 includes a slot 560 which is configured to receive the locking rib 540 as described further below. FIG. 5.6 shows a top view of a portion of carrier 110 showing configuration of the 520 in the bottom 192 of channel 190.

To mount a shelf 120 to a carrier 110, the shelf is positioned so that the barrel 180 can be inserted into the channel 190 of carrier 110 with the paddle 510 passing through an aperture 520 in the carrier. The paddle 510 and aperture 520 can each be configured so the shelf can be inserted while angled diagonally relative to the carrier 110, such as shown in FIG. 4.3, but restrained in place when the shelf 120 is in the closed or open position. After shelf 120 is diagonally mounted to the carrier 100 with the paddle 510 through the aperture 520, the shelf 120 can be opened or closed relative to carrier 110.

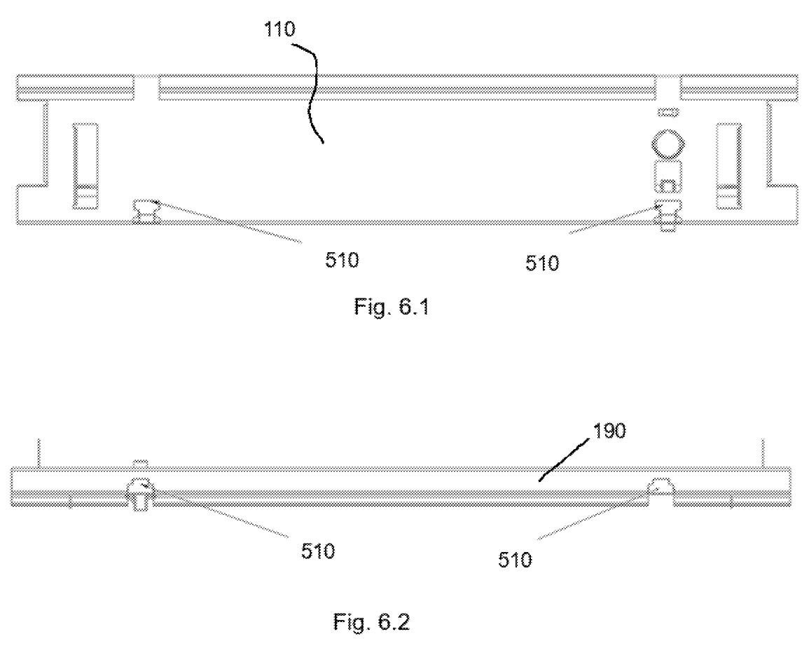

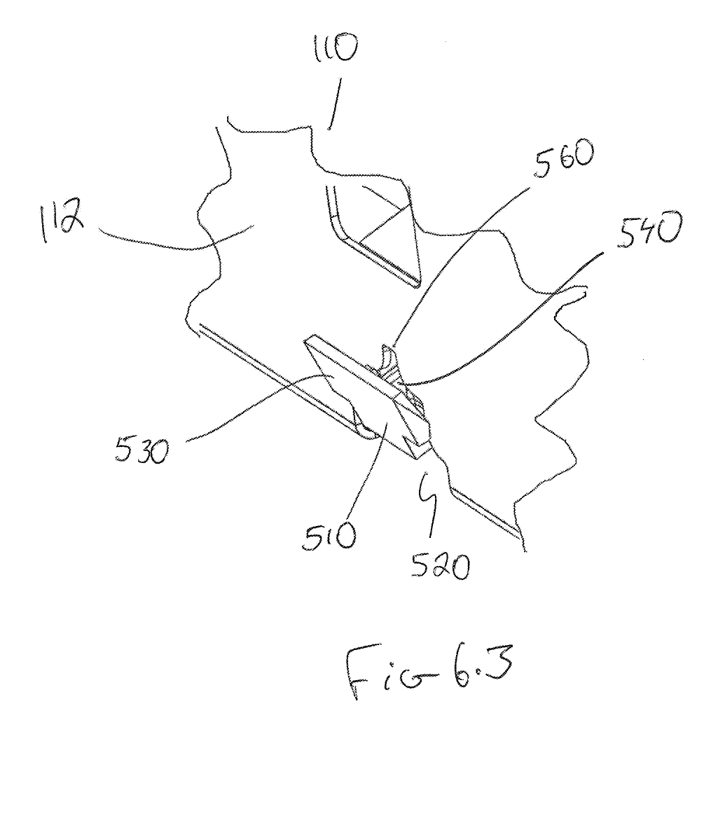

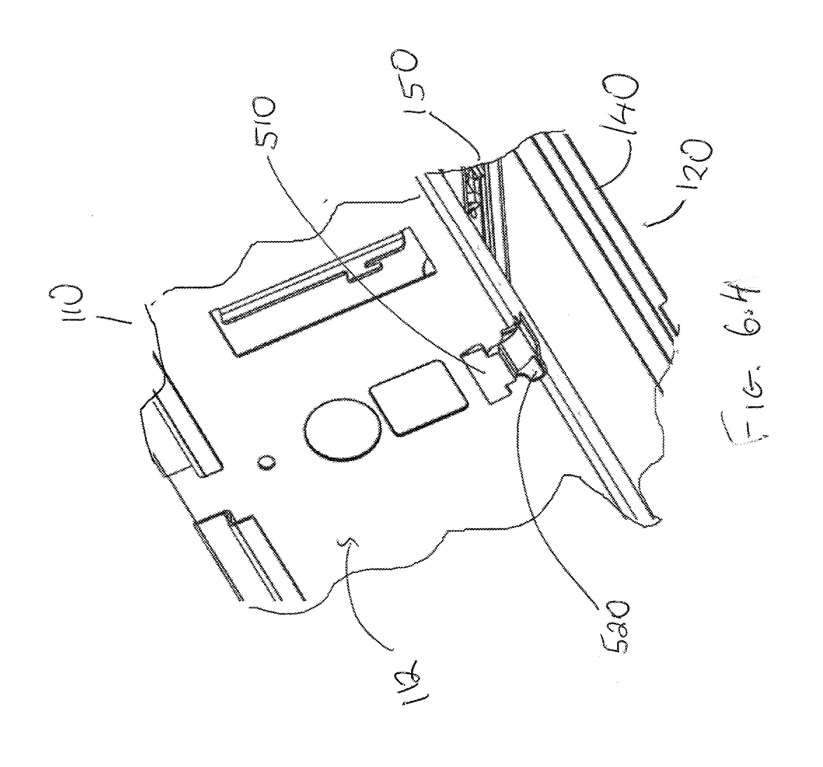

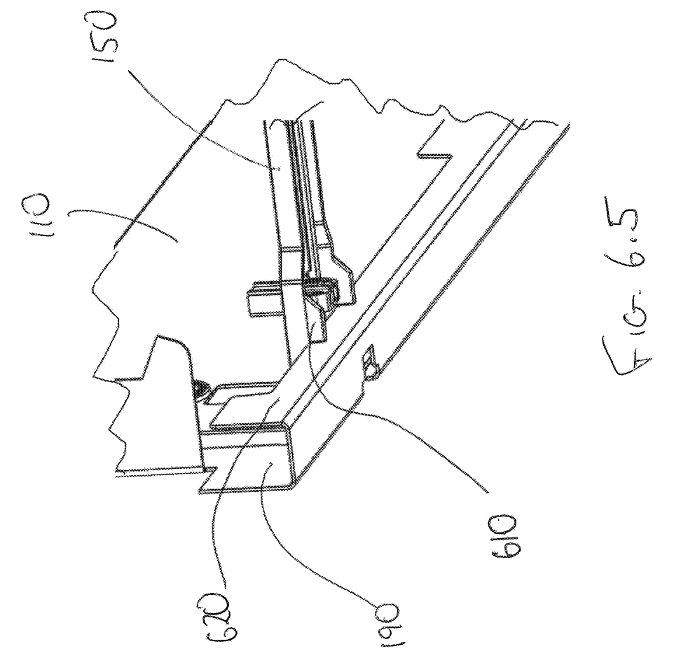

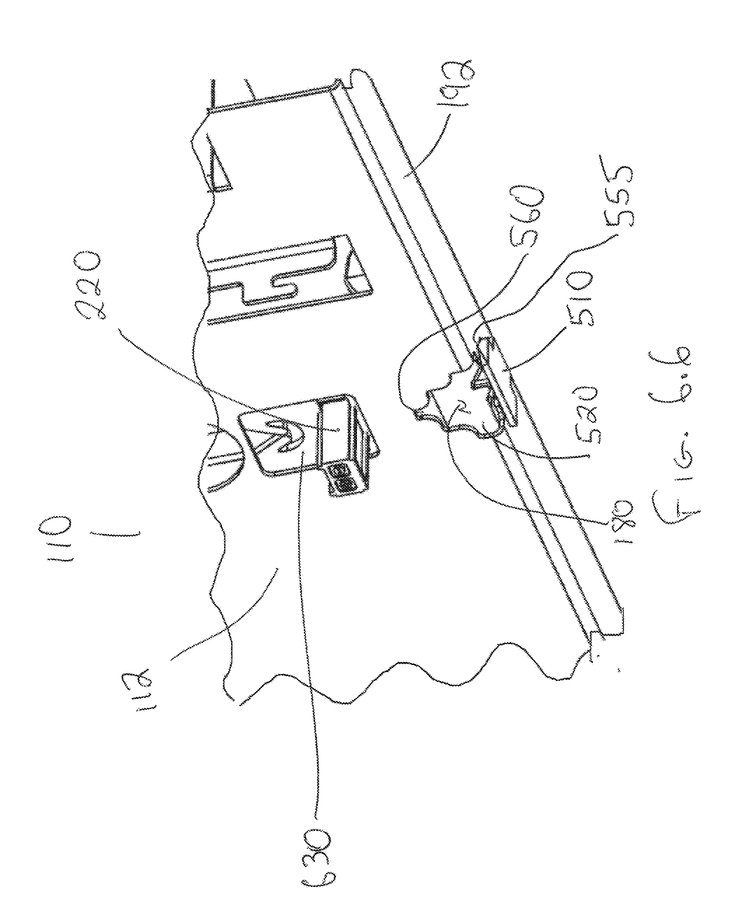

FIG. 6.1 is a rear view of assembly 100 with the shelf 120 in the open position. FIG. 6.2 is a bottom view of assembly 100 with the shelf 120 in the closed position. In the open and closed positions, the interaction of the paddle 510 and aperture 520 lock the shelf in place.

FIG. 6.3 is a partial rear perspective view of the shelf assembly 100 in a partially opened position. FIG. 6.4 is a partial bottom rear perspective view of the shelf assembly 100 in the fully opened position. As the shelf 120 is rotated to the open position, the paddle 510 rotates so that the rib 540 engages the slot 560 in aperture 520. When so engaged, the rib 440 locks the shelf 120 in position to prevent lateral movement relative to the carrier 110. The beveled portion 550 the arms 530 can be configured so that as the shelf is moved to the closed position, t

FIG. 6.5 is a partial bottom front perspective view of the shelf 120 in the opened position. The rear portion of the support arms 150 can have one or more downwardly extending ribs 610 that engage a forward portion 620 of the channel 190 to support the shelf 120 in its open position Ribs 610 can be configured to support the shelf 120 at a slight incline. In addition, and with reference to FIG. 6.5, when the shelf 120 is fully opened, the face of arms 530 of the paddle 510 can also engages the back wall 112 of carrier 110 limiting how far down shelf can be rotated, providing additional support. The relative positions of the paddle arms 530 to the rear wall 112 of the carrier 110 and the ribs 610 to the forward portion 620 of the channel can be selected so to provide a snug fit to prevent front-to-back movement of the shelf 110 when in the open position.

FIG. 6.6 is a partial rear perspective view of the shelf assembly 100 with the shelf 120 in the closed position. When the shelf 120 is moved to the closed position, the barrel 180 rotates in the channel 190. This moves paddle 410 in the aperture 420 so that the arms 430 engage a bottom portion 192 of the channel 190. This locks the shelf 120 in place so it cannot be removed from the carrier 110. The cam surface 555 is configured so that as the shelf is moved to the closed position, it 550 presses against the bottom surface 192 of the channel 190 pulls the barrel 180 down within the channel to increase friction and help hold the shelf 120 in the closed position. This allows the folded shelf to be more easily handled for shipping and for installation when it is mounted to a support wall.

In embodiments where the first connector portion 220 extends upwards from the shelf 120, an aperture 630 can be formed in the back wall 112 of the carrier 110 and positioned to allow the connector portion 220 to pass through.

Various aspects, embodiments, and examples of the invention have been disclosed and described herein. Modifications, additions and alterations may be made by one skilled in the art without departing from the spirit and scope of the invention as defined in the appended claims.

1. A modular shelving assembly comprising a carrier configured to be mounted to a support wall and a shelf configured to attach to the carrier to form a hinge that allows the shelf to be opened or folded up against the carrier.
